(19) United States
(12) Patent Application Publication
(10) Pub. No.: US 2020/0391326 A1
(43) Pub. Date: Dec. 17, 2020

(54) METHOD OF CREATING AN INTERIOR METAL FLOW OPENING IN A METAL SHEET DURING A FORMING OPERATION

(71) Applicants: Dajun Zhou, Troy, MI (US); Thomas W Cox, Oxford, MI (US); Kaiping Li, Shelby Township, MI (US); Yongjun Zhou, Rochester Hills, MI (US); Richard Siemen, Shelby Township, MI (US); Robert D Miller, Lake Orion, MI (US)

(72) Inventors: Dajun Zhou, Troy, MI (US); Thomas W Cox, Oxford, MI (US); Kaiping Li, Shelby Township, MI (US); Yongjun Zhou, Rochester Hills, MI (US); Richard Siemen, Shelby Township, MI (US); Robert D Miller, Lake Orion, MI (US)

(21) Appl. No.: 16/439,176

(22) Filed: Jun. 12, 2019

(51) Int. Cl. B23K 26/38; B21D 31/00

(52) U.S. Cl. CPC B23K 26/38; B23K 2101/18; B21D 31/00

(57) ABSTRACT

Segment openings are formed in a metal sheet separated by uncut sections at a first processing station, which define an inner blank portion of the metal flow opening. At a second processing station, the uncut sections and the inner blank portion initially transfer stress around the segment openings and across the interior flow opening during a forming operation. During the forming operation, a protrusion of one mold member contacts a first side of the inner blank portion of the interior flow opening. In addition, another mold member is contact the opposite side of the metal sheet so that the mold members cooperate to separate all but one of the uncut sections by which the inner blank portion remains attached to the metal sheet. In this way, the interior metal flow opening is completed without piercing the metal sheet at the second processing station during the forming operation.

### FIELD

The present disclosure relates to methods of creating an interior metal flow opening in a metal sheet during a forming operation.

### BACKGROUND

Lancing has been used in sheet metal forming to pierce a metal sheet during a forming operation in order to cut an interior metal flow opening in the sheet to increase outward metal flow, when inward metal flow from the binder is not enough to prevent splitting of the sheet metal; for example, when a deep or complicated shape, such as an inner door, is being formed. The portion of the blank that is cut to form the interior metal flow opening remains attached along an uncut connecting portion so that it is transferred out of the mold with the formed sheet. The interior metal flow opening is made in an interior portion of the sheet metal that will be removed from the final panel subsequent to the forming operation that includes the pierce-lancing.

Used smartly, such a pierce-lancing process cuts interior metal flow openings with the right shapes, in the right locations, and at the right times in the forming process. The cut edge of the interior metal flow openings is a free edge, which provides additional outward flow of material to enable the forming of difficult make features nearby. Such a pierce-lancing process has been particularly beneficial in making deep draw panels, such as door inner and body-side panels, or panels having complicated shapes.

Pierce-lancing, however, has fallen out of favor over the last decade in some large volume mass production stamping plants. Today, many automobile OEM die standards don't even mention pierce-lancing or provide pierce-lancing design guideline and parameters. The major problem with pierce-lancing is the debris generated by lancing tool in a fast and high volume production. Although the portion of the blank that is cut to form the interior metal flow opening is transferred out of the mold with the formed sheet, pierce-lancing generates debris that accumulates in the mold over time.

With reference to FIG. 1A, a pierce-lancing cutter 10 of a lower forming mold 11 has a sharp piercing tip 12 that rubs and slides along the moving metal sheet 14 as the sheet 14 is being stretched and formed. As relative movement of the lower forming mold 11 towards an upper forming mold 13 of the metal forming operation continues the sharp piercing tip 12 rubs and slides along the moving metal sheet 14 with increasingly high pressure until the piercing tip 12 finally penetrates the sheet 14. This high pressure sliding or rubbing contact generates metal debris prior to the penetration of the piercing tip 12.

With reference to FIG. 1A, as the cutter 10 pierces and penetrates the metal sheet 14 the freshly made edges 16 of the metal sheet 14 rub and slide along the sides 18 of the pierce-lancing cutter 10 as it moves upward to finish forming the interior metal flow opening and then withdraws from the metal sheet 14. This sliding or rubbing contact generates addition& metal debris during and after formation of the interior metal flow opening. Thus, metal debris is generated within the mold before, during, and after formation of the interior metal flow opening using a pierce-lancing process. With pierce-lancing, the production line must be periodically shut down so that someone can be sent into the press to remove the debris that has accumulated from the pierce-lancing of the interior metal flow openings.

### SUMMARY

In one aspect, a non-piercing method of creating an interior metal flow opening in a metal sheet during a forming operation to facilitate outward metal flow from the metal flow opening during the forming operation is provided. The non-piercing method includes cutting a series of segment openings in the metal sheet separated by uncut sections at a first processing station. The series of segment openings and uncut sections together define an inner blank portion of the metal flow opening. The portion of the metal sheet having the segment openings and the uncut sections is transferred to a second processing station. During an initial phase of the forming at the second processing station, the uncut sections and the inner blank portion transfer stress around the segment openings and across the interior flow opening. During a subsequent phase of the forming at the second processing station, a protrusion of a first of the mold members is brought into contact with a first side of the metal sheet at the inner blank portion of the interior flow opening. In addition, a second of the mold members is brought into contact with a second, opposite side of the metal sheet to separate all but one of the uncut sections by which the inner blank portion remains attached to the metal sheet. The interior metal flow opening is completed without piercing the metal sheet at the second processing station during the forming operation.

In an aspect, the cutting the series of segment openings at the first processing station includes laser cutting the series of segment openings. In an aspect, the laser forming is part of a laser blanking operation at the first processing station.

In an aspect, the cutting the series of segment openings at the first processing station includes die cutting the series of segment openings. In an aspect, the die cutting is part of a die blanking operation at the first processing station.

In an aspect, the causing the protrusion of the first of the mold members to contact the first side of the metal sheet includes a punch moving outwardly relative to the first of the mold members to contact a first side of the metal sheet.

In an aspect, the protrusion of the first of the mold members and the second mold member cooperate to separate the metal sheet along the uncut sections by tearing along the uncut sections.

In an aspect, the protrusion of the first of the mold members and the second mold member cooperate to separate the metal sheet along the uncut sections by cutting along the uncut sections.

In an aspect, the non-piercing process additionally includes coating the protrusion with a diamond-like carbon (DLC) coating.

In an aspect, the further comprising coating the protrusion with a diamond-like carbon (DLC) coating

In an aspect, the metal sheet is an aluminum metal sheet that is transferred between the two processing stations and in which the metal flow opening is formed.

In an aspect, several series of segment openings separated by uncut sections are formed in the metal sheet at the first processing station, and a corresponding number of interior metal flow openings are completed in the metal sheet during the forming operation at the second processing station. In an aspect, the corresponding number of interior metal flow openings are completed in the metal sheet at different times during the forming operation at the second processing station.

### DRAWINGS

The present invention will become more fully understood from the detailed description and the accompanying drawings.

FIGS. 1A and 1B are simplified cross-sectional views related to a prior art pierce-lancing method of creating an interior metal flow opening in a metal sheet during a forming operation.

FIG. 2 are simplified cross-sectional views of a first and a second processing station related to an example method of creating an interior metal flow opening in a metal sheet during a forming operation in accordance with the present disclosure.

FIG. 3 is a simplified top plan view of a portion of a metal sheet in the process between the first and second processing stations of FIG. 2.

FIGS. 4A and 4B are simplified cross-sectional views related to aspects of the example method occurring at the second processing station of FIG. 2.

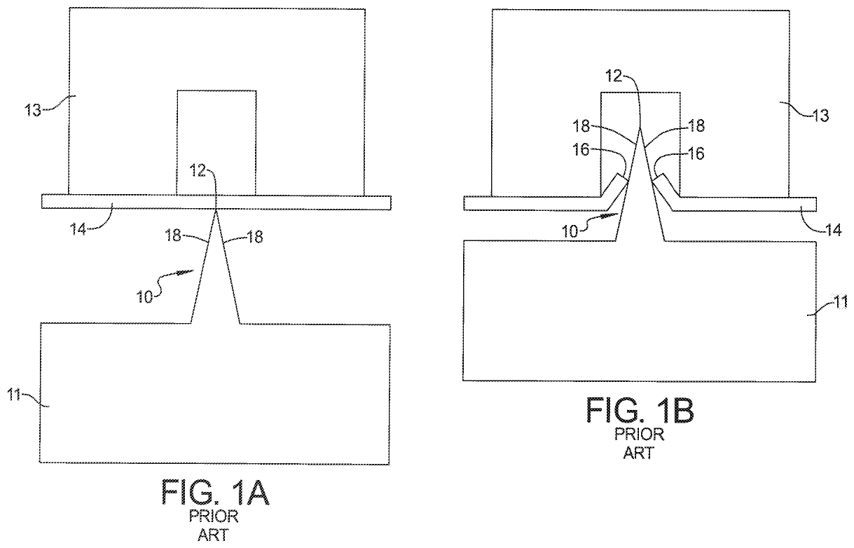

### DETAILED DESCRIPTION

Further areas of applicability will become apparent from the description, claims and drawings, wherein like reference numerals refer to like features throughout the several views of the drawings. It should be understood that the detailed description, including disclosed embodiments and drawings referenced therein are merely exemplary in nature, intended for purposes of illustration only, and are not intended to limit the scope of the present disclosure.

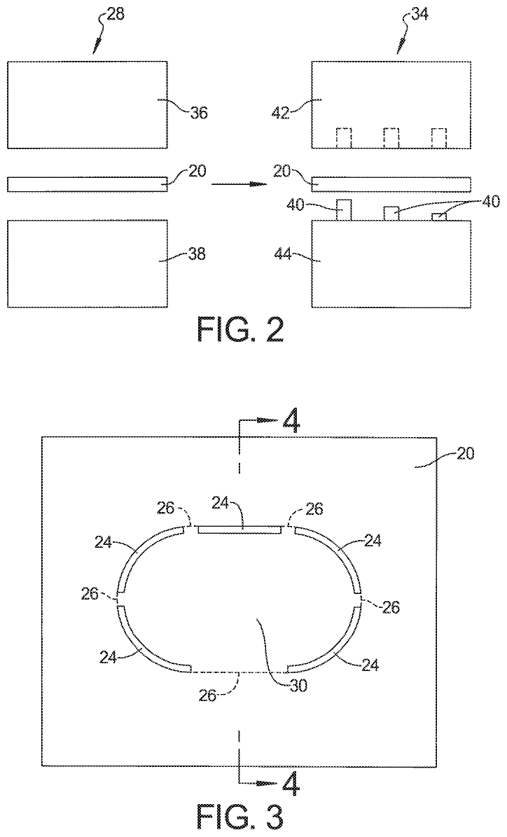

With reference to FIGS. 2-4B, one example of a non-piercing method of creating an interior metal flow opening 32 during a forming operation in a metal sheet 20 to thereafter facilitate outward metal flow from the metal flow opening 32 during the forming operation is described below. In this example the metal sheet is an aluminum metal sheet 20. Alternatively, the metal sheet is an steel metal sheet 20. This example process includes cutting a series of segment openings 24 in the metal sheet 20 separated by uncut sections 26 at a first processing station. Together, the segment openings 24 and uncut sections 26 define an inner blank portion 30 of the interior metal flow opening 32 at the first processing station 28 as well as the boundaries of a future interior metal flow opening 32. The segment openings 24 formed at the first processing station 28 operate as separation initiating openings 24 from which subsequent cutting, tearing or other separation action along the uncut sections 26 can be initiated to create the interior flow opening 32.

The first processing station 28 is a die blanking station that includes die components 36, 38 that operate to die cut the series of segment openings 24 in the metal sheet 20 as part of a die blanking operation. Alternatively, the first processing station 28 is a laser blanking station that includes laser cutting components 36, 38 that operate to laser cut the series of segment openings 24 as part of a laser blanking operation.

The portion of the metal sheet 20 having the segment openings 24 and the uncut sections 26 is transferred from the first processing station 28 to a second processing station 34. The second processing station 34 is a drawing or forming station. At the second processing station, the portion of the metal sheet 20 by relative movement of two mold members 36, 38 undergoes a forming operation. During an initial phase of the forming operation at the second processing station 34, the uncut sections 26 and inner blank portion 30 operate to transfer stress around the segment openings 24 and across the interior flow opening 32. Thus, outward metal flow from the interior flow opening 32 is restricted during this initial forming phase at the second processing station.

During a subsequent phase of the forming at the second processing station 34, a protrusion 40 of one of the mold members 44 contacts a first side of the metal sheet 20 at the inner blank portion 30 of the interior flow opening 32. The other mold member 42 contacts the opposite, second side of the metal sheet 20 outside the inner blank portion 30 to separate all but one of the uncut sections 26. In this way, the inner blank portion 30 remains attached to the metal sheet 20 with the interior flow opening 32 being fully formed or completed. In addition, the interior metal flow opening 32 achieves this completion without piercing the metal sheet during the forming operation at the second processing station.

In this example, the protrusion 40 of the mold member 44 is a punch that is movable outwardly relative to the mold member 44 to contact the metal sheet 20. Alternatively, the protrusion 40 of the mold member 44 is a part of the mold member 44 that is brought into contact with the metal sheet 20 solely due to relative movement of the mold members 44, 42 toward each other during the forming operation.

As shown in FIG. 2, the example includes the mold member 44 having several protrusions 40 so that several interior metal flow openings 32 are formed in the metal sheet 20 during the forming operation at the second processing station 34. For example, 2, 3, 4, 5, or more interior metal flow openings 32 are formed in the metal sheet 20 during the forming operation at the second processing station 34. Alternatively, a single interior metal flow opening 32 is formed in the metal sheet 20 during the forming operation at the second processing station 34.

As shown in FIG. 2, the different protrusions 40 are operable to engage the metal sheet 20 at different times during the forming operation so that the interior metal flow openings 32 are formed in the metal sheet 20 at different times during the forming operation at the second processing station 34. Thus, the initiation of outward metal flow from the different interior metal flow openings 32 occurs at different times during the forming operation at the second processing station 34. Alternatively, the different protrusions 40 operate to engage the metal sheet 20 at the same time to simultaneously form all of the interior metal flow openings 32 in the metal sheet 20.

As shown in FIG. 3, the uncut sections 26 of an interior metal flow opening 32 all have the same length, except for the uncut section 26 that remains uncut after the interior metal flow opening 32 is completed. Alternatively, the uncut sections 26 of an interior metal flow opening 32 have different lengths so that the order in which separation occurs along the different uncut sections 26 is controlled. Additionally or alternatively, each of several interior metal flow openings 32 in a metal sheet 20 have uniform length uncut sections 26 as noted above, but this uniform length for each interior metal flow openings 32 is different so that the different interior metal flow openings 32 are formed in the metal sheet 20 at different times during the forming operation at the second processing station 34.

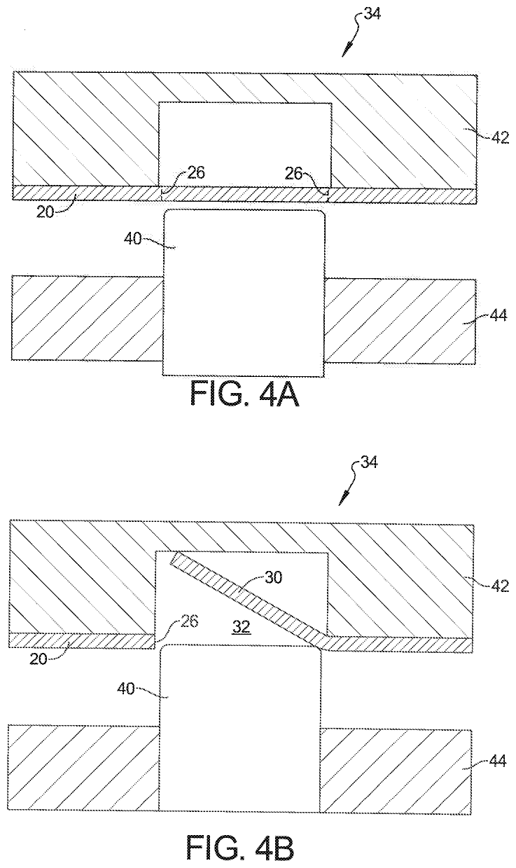

As shown in FIGS. 4A and 4B, the protrusion 40 of the mold member 44 and the mold member 42 contact the opposite sides of the metal sheet in a way that they cooperate to separate the metal sheet 20 along the uncut sections 26 by tearing along the uncut sections 26. Alternatively, the protrusion 40 of the mold member 44 and the mold member 42 contact the opposite sides of the metal sheet in a way that they cooperate to separate the metal sheet 20 along the uncut sections 26 by cutting along the uncut sections 26.

Potential metal debris is reduced in view of the fact that the protrusions 40 of the example process have a flat, rather than a pointed, engagement surface with the metal sheet 20. A diamond-like carbon (DLC) coating can be applied to the protrusions 40 to also reduce potential debris from friction between the protrusion 40 and the metal sheet 20. Such DLC coatings typically include combinations of carbon and tungsten or carbon, tungsten and chromium nitride. Examples of DLC coatings are sold by IHI Ionbond AG under the tradename Tetrabond™. Additional information about DLC coatings is provided in a presentation entitled “Wear and Galling Behavior of Coated Tools Used in Pierce Punching of Automotive Aluminum Sheet” by Shafiei et al. delivered at the International Deep-Drawing Research Group in June of 2018.

As used herein, “non-piercing” and “without piercing” means without having to simultaneously initiate an opening through the metal sheet in order to separate different portions of the metal sheet from each other. In other words, there is at least one pre-existing opening through the sheet metal from which separation along the metal sheet is initiated.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A non-piercing method of creating an interior metal flow opening in a metal sheet during a forming operation to facilitate outward metal flow from the metal flow opening during the forming operation, the method comprising:
at a first processing station, cutting a series of segment openings in the metal sheet separated by uncut sections, which together define an inner blank portion of the metal flow opening;
transferring a portion of the metal sheet having the segment openings and the uncut sections to a second processing station;
at the second processing station, forming the portion of the metal sheet by relative movement of two mold members;
during an initial phase of the forming at the second processing station, the uncut sections and the inner blank portion transferring stress around the segment openings and across the interior flow opening;
during a subsequent phase of the forming at the second processing station, causing a protrusion of a first of the mold members to contact a first side of the metal sheet at the inner blank portion of the interior flow opening and a second of the mold members to contact a second, opposite side of the metal sheet to separate all but one of the uncut sections by which the inner blank portion remains attached to the metal sheet;
wherein the interior metal flow opening is completed without piercing the metal sheet at the second processing station during the forming operation.

2. The non-piercing method of claim 1, wherein the cutting the series of segment openings at the first processing station comprises laser cutting the series of segment openings.

3. The non-piercing method of claim 2, wherein the laser forming is part of a laser blanking operation at the first processing station.

4. The non-piercing method of claim 1, wherein the cutting the series of segment openings at the first processing station comprises die cutting the series of segment openings.

5. The non-piercing method of claim 4, wherein the die cutting is part of a die blanking operation at the first processing station.

6. The non-piercing method of claim 1, wherein the causing the protrusion of the first of the mold members to contact the first side of the metal sheet comprises a punch moving outwardly relative to the first of the mold members to contact a first side of the metal sheet.

7. The non-piercing method of claim 1, wherein the protrusion of the first of the mold members and the second mold member cooperate to separate the metal sheet along the uncut sections by tearing along the uncut sections.

8. The non-piercing method of claim 1, wherein the protrusion of the first of the mold members and the second mold member cooperate to separate the metal sheet along the uncut sections by cutting along the uncut sections.

9. The non-piercing method of claim 1, further comprising coating the protrusion with a diamond-like carbon (DLC) coating.

10. The non-piercing method of claim 1, wherein the metal sheet is an aluminum or steel metal sheet.

11. The non-piercing method of claim 1, wherein several series of segment openings separated by uncut sections are formed in the metal sheet at the first processing station, and a corresponding number of interior metal flow openings are completed in the metal sheet during the forming operation at the second processing station.

12. The non-piercing method of claim 11, wherein the corresponding number of interior metal flow openings are completed in the metal sheet at different times during the forming operation at the second processing station.
